(19) United States
(12) Patent Application Publication
(10) Pub. No.: US 2019/0318425 A1
(43) Pub. Date: Oct. 17, 2019

(54) ENERGY FUTURE TOKEN PLATFORM

(71) Applicant: DRIFT MARKETPLACE, INC., Seattle, WA (US)

(72) Inventors: Alan Tilley, Seattle, WA (US); Gregory William Robinson, Seattle, WA (US)

(21) Appl. No.: 16/385,513

(22) Filed: Apr. 16, 2019

Related U.S. Application Data
(60) Provisional application No. 62/658,463, filed on Apr. 16, 2018.

(51) Int. Cl. G06Q 40/04; G06Q 20/38

(52) U.S. Cl. CPC G06Q 40/04; G06Q 20/389

(57) ABSTRACT

A system is provided for recording in a blockchain future tokens representing interest in future revenue to support building of a renewable energy plant. The system receives an issue specification indicating number of future tokens and their maturity dates that are to be issued and an owner of the future tokens. For each future token for a maturity date of the issue specification, the system creates a future token indicating the maturity date and the owner. The system then records the future tokens in the blockchain. The system records transactions to transfer ownership of future token to investors in the renewable energy plant and transactions to indicate when a future token has matured because an investor has been paid according to terms of the investment.

### CROSS-REFERENCE TO RELATED APPLICATION

This application claims the benefit of U.S. Provisional Application No. 62/658,463, filed on Apr. 16, 2018, which is hereby incorporated by reference in its entirety.

### BACKGROUND

The electrical grid is a network of suppliers and consumers of energy. The electrical grid includes a transmission grid and a distribution grid. Suppliers of large amounts of energy (e.g., hydroelectric plants and nuclear plants) supply high voltage electrical power to the transmission grid for transmission to substations. The substations step the high voltage electrical power of the transmission grid to lower voltage electrical power of the distribution grid. Consumers connect to the distribution grid to obtain their electrical power. Various suppliers such as city power plants, solar farms, and wind farms may also connect to the distribution grid to supply electrical power.

To incentivize the production of renewable energy (e.g., electricity generated via solar, hydroelectric, wind, and so on), renewable energy credits (“RECs”) are issued to suppliers of renewable energy. A REC signifies that the suppler generated 1 MWh (i.e., megawatt-hour) of renewable energy. Each REC has a unique identification number registered with a certifying entity. RECs are tradable, non-tangible energy commodities that represent proof that electricity was generated from an eligible renewable energy source and was fed into the electrical grid.

Even though RECs are provided to incentivize production of renewable energy, the cost of developing a renewable energy power plant can be quite high. Because of the cost and complexity of financing such power plants, the number of entities willing to invest in the development of such power plants is very limited. The number is limited because only a relatively small number of entities (e.g., large entities) have both the financial resources to finance large amounts and the sophistication to handle complexity of such financing. Many entities (e.g., individual investors) do not have the financial resource and sophistication to participant in such financing. It would be desirable to have a computing system that would make it easier for these entities to participate in such financing.

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity, and when performing actions against tokens, ownership proof is established by providing a signature generated by the owner private key and validated against the public key listed as the owner of the token. A person can be uniquely identified, for example, using a combination of a user name, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring) involving the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by the car's vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner, and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, it requires large amounts of computer resources to support such redundant execution of computer code.

Although blockchains can effectively store transactions, the large amount of computer resources, such as storage and computational power, needed to maintain all the replicas of the blockchain can be problematic. To overcome this problem, some systems for storing transactions do not use blockchains, but rather have each party to a transaction maintain its own copy of the transaction. One such system is the Corda system developed by R3, Ltd., which provides a decentralized distributed ledger platform in which each participant in the platform has a node (e.g., computer system) that maintains its portion of the distributed ledger. When parties agree on the terms of a transaction, a party submits the transaction to a notary, which is a trusted node, for notarization. The notary maintains an UTXO database of unspent transaction outputs. When a transaction is received, the notary checks the inputs to the transaction against the UTXO database to ensure that the outputs that the inputs reference have not been spent. If the inputs have not been spent, the notary updates the UTXO database to indicate that the referenced outputs have been spent, notarizes the transaction (e.g., by signing the transaction or a transaction identifier with a public key of the notary), and sends the notarization to the party that submitted the transaction for notarization. When the party receives the notarization, the party stores the notarization and provides the notarization to the counterparties.

### BRIEF DESCRIPTION OF THE DRAWINGS

FIG. 1 flow diagrams that illustrate the processing of the FTP system in some embodiments.

FIG. 2 is a block diagram that illustrates systems that interact with the FTP system in some embodiments.

FIG. 3 is a diagram that illustrates various transactions that are recorded in the distributed ledger by the FTP system in some embodiments.

FIG. 4 illustrates components of various smart contracts in some embodiments.

FIG. 5 is a flow diagram that illustrates the processing of an FTP initialize component.

FIG. 6 is a flow diagram that illustrates the processing of a commit message component of the FTP smart contract in some embodiments.

FIG. 7 is a flow diagram that illustrates the processing of a commit component of the FTP smart contract in some embodiments.

FIG. 8 is a flow diagram that illustrates the processing of a commit message component of a commit token smart contract in some embodiments.

FIG. 9 is a flow diagram that illustrates the processing of a revenue message component of a total revenue transaction smart contract in some embodiments.

FIG. 10 is a flow diagram that illustrates the processing of a settlement message component of the total revenue smart contract in some embodiments.

FIG. 11 is a flow diagram that illustrates the processing of a payment message component of a daily revenue index smart contract in some embodiments.

FIG. 12 is a flow diagram that illustrates the processing of a settlement message component of a daily revenue index smart contract in some embodiments.

FIG. 13 is a flow diagram that illustrates the processing of a transfer message component of a future token smart contract in some embodiments.

FIG. 14 is a flow diagram that illustrates the processing of redeem message component of exchange token smart contract in some embodiments.

FIG. 15 illustrates an example of pricing for FTs in some embodiments.

FIG. 16 is a flow diagram that illustrates a component for issuing FTs of the FTP system in some embodiments.

FIG. 17 is a flow diagram that illustrates a component for transferring FTs of the FTP system in some embodiments.

FIG. 18 is a flow diagram that illustrates processing of a redeem FTs component of the FTP system in some embodiments.

FIG. 19 is a flow diagram that illustrates processing of a calculate FTP index component of the FTP system in some embodiments.

### DETAILED DESCRIPTION

A method and a system are provided for issuing, via a distributed ledger, future tokens ownership of interest in revenue in future energy output of an energy plant. The funds received from the sale of future tokens may be used to build the energy plant, support ongoing operations of the energy plant, and so on. In some embodiments, a future token platform (“FTP”) system is provided that allows an energy supplier to register an energy project with the FTP system and a financing plan to receive funds from the sale of future tokens (“FTs”) recorded in a distributed ledger to support the financing of the energy project. For example, when an energy supplier is to build a new energy plant (e.g., solar or wind), the financing plan of the energy project to build that energy plant may include providing information of a power purchase agreement (“PPA”) between the energy supplier and an energy consumer (e.g., off-taker). The PPA specifies the amount of energy (e.g., kilowatts per day) that the energy consumer will purchase over a specified time period. The FTP system is used to develop an FT plan to sell FTs to support the financing. The funds collected from the sale of the FTs can be used, for example, to pay a general contractor responsible for construction of the energy plant or to pay back a financial institution who funded the construction after the construction is complete.

In some embodiments, each FT may have an associated par value at maturity and a maturity date. (In the following, the par value is described as being $1.00, but can be any amount in any currency such as fiat currency or cryptocurrency or other assets such as gold bars.) The maturity date of an FT indicates the date on which the owner of the FT can redeem the FT for payment of the par value. To sell the FTs, the FTP system records a number of FTs corresponding to the anticipated revenue over the term of the PPA. For example, if the amount of anticipated revenue $480,000, the FTP system records 480,000 FTs. The initial owner of the FTs may be the FTP system or the power supplier. The FTs have maturity dates that span the term of the PPAs. For example, if the term is 25 years and assuming an equal amount of power is generated each month, the FTP system may record 1,600 FTs for each month of the 25 years (i.e., $480,000/(25*12)) that have a maturity date at the end of that month. Thus, 1,600 FTs will have a maturity date of January, 1,600 FTs will have a maturity date of February, and so on for 25 years.

To raise the money to finance the construction project, the FTP system sells the FTs to investors. For example, if $300,000 is needed for financing, the FTP sets the price of the FTs so that the total amount from the sale is $300,000. Because the FTs have different maturity dates, the net present value of FTs with later maturity dates will be less. As a result, investors will likely only be willing to pay less for FTs with later maturity date. The pricing of FTs and the setting of maturity dates of the FT may thus be based on the market for FTs. When an investor purchases FTs, the investor specifies the desired number of FTs and desired maturity dates of the FTs to be purchases. For example, an investor may want to purchase 1200 FTs with 100 FTs maturity dates every month of the 10th year of the PPA. Upon payment, the FTP system transfers to the investors the desired number of FTs for each desired maturity date.

To redeem an FT, the owner submits it to the FTP system on or after the maturity date. The FTP system then makes the payment to the owner for the par value and marks the FT as having been redeemed. For example, the FTP system may record a redeemed transaction in the distributed ledger referencing the redeemed FT. Prior to redemption, the owner of an FT can transfer ownership of the FT to a new owner by recording a transfer transaction in the distributed ledger indicating the new owner. Alternatively, the FTP system can record the transfer transaction in response to receiving the request from the owner of the FT.

In some embodiments, the FTs may have a maturity date that is variable based on the actual revenue of the energy plant. If the actual revenue is less than the anticipated revenue, there will not be enough revenue to cover the value of the FTs as they mature. In such a case, the maturity date of an FT may be extended, for example, a month at a time until there is enough revenue to cover the value of the FTs. Similarly, if the actual revenue is more than anticipated, the maturity dates could be moved up.

The FTP system may have a number of energy plants that are registered with it. The FTP system may receive and aggregate revenue of the energy plants and use the aggregate revenue to fund the redeeming of tokens. The use of the aggregated revenue allows the FTP system to pay for the redemption of an FT even though an energy plant for which an FT was issued has had less than anticipated revenue, for example, because the amount of wind at a wind farm was less than anticipated.

In the energy industry, to ensure that an energy consumer has sufficient power when needed, the energy consumer may enter into contracts to purchase power when needed generated by energy plants registered with the FTP system. The contracts may be with energy suppliers of power or other parties who have purchased the rights to power. For example, a contract may specify that a certain amount power will be purchased for a certain price each month of a calendar year that is five years in the future.

To provide information to assist in both pricing of FTs and pricing of such contracts, the FTP system may publish an FTP index. The FTP index may be the aggregated revenue divided by the number of FTs that have matured. For example, if the aggregated revenue is equal to the number of FTs that have matured, the FTP index is 1.0. When the aggregated revenue is less than or more than the number of FTs that have matured, the FTP index is less than or more than 1.0, respectively. When the energy plant is a renewable energy plant, the revenue is derived from grid prices (e.g., location-based marginal price) plus amounts paid by energy consumers that the energy is renewable or by governmental entities to incentive production of renewable energy.

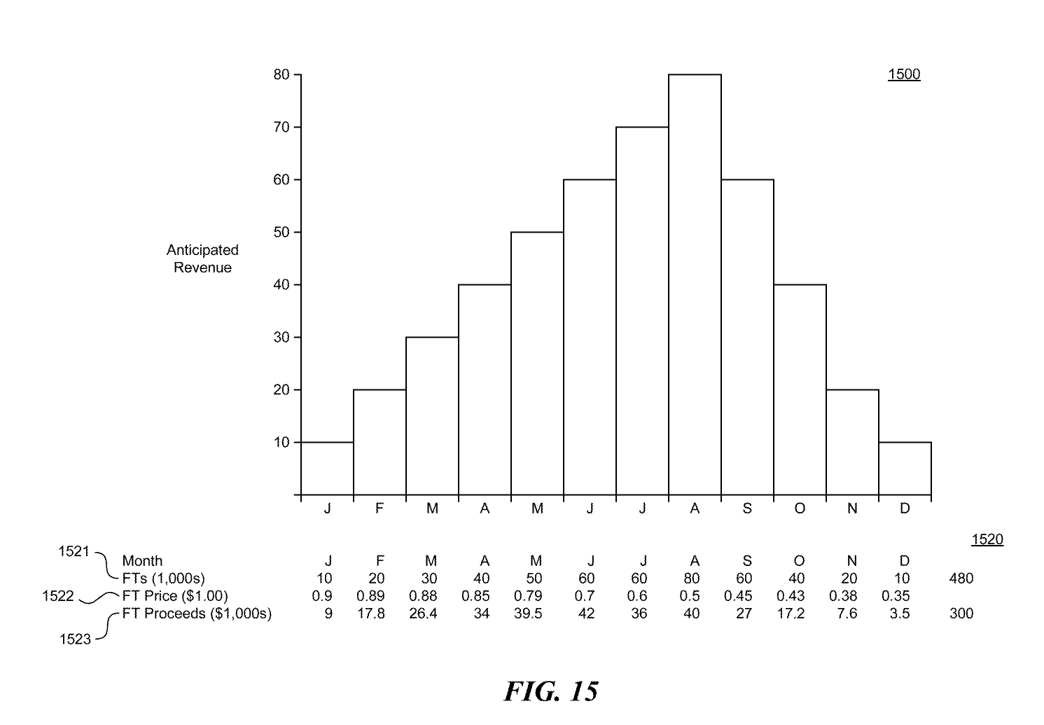

FIG. 15 illustrates an example of pricing for FTs in some embodiments. Graph 110 illustrates the anticipated revenue of solar energy plants per month over the course of a year. The anticipated revenue is lowest in January and December and highest in August. The total anticipated revenue is $480,000. If the energy supplier needs to raise $300,000, the FTP system may issue for each month a number of FTs that is in proportion to the anticipated revenue for that month. Table 120 illustrates the issuance and sale of FTs. The FT row 1521 indicates for each month the number of FTs with that month as its maturity date. For example, the number of FTs issued with a January maturity date is 10,000 and with an August maturity date is 80,000. The FT price row 1522 illustrates the sale price of each FT. For example, the sale price of FTs with a January maturity date is $0.90 and with an August maturity date is $0.50. (Note: The pricing is for illustration purposes and is not intended to be realistic.) The FT proceeds row 1523 illustrates the proceeds from the sale of FTs for each maturity date. For example, the proceeds from the FTs with a January maturity date is $9,000 and with an August maturity date is $40,000. The sum of the proceeds is $300,000, which is the amount the energy supplier needs to raise. In some embodiments, FTs may be issued with a par value greater than the minimum par value (e.g., $1.00). For example, if an investor purchases 1,000 FTs with the par value, an FT with a par value of 1,000 times (e.g., $1,000) the minimum par value. An FT may be split into other FTs with par values that sum to the par value of the split FT. FTs may be combined into a single FT with a par value that is the sum of the par values of the combined FTs. The actions taken on the FTs such as combining, splitting, transferring, and redeeming may be implemented using smart contracts of the distributed ledger.

As an alternative model to the aFTP system, an alternative aFTP (“aFTP”) system is provided that allows a project to be registered and receives from an originator of the revenue stream associated with the project an indication of an allocation number of future tokens. The originator may be, for example, a developer of an energy plant, such as a solar energy plant, who wants to solicit funds to finance the building of the energy in exchange for a portion of the revenue stream of the energy plant. The aFTP system then records in the distributed ledger (e.g., an Ethereum-based blockchain) the allocation number of future token transactions with the originator as the original owner. Each future token transaction entitles the owner (i.e., of the future token) to a fixed amount of the revenue stream. For example, if a developer wants to raise $250,000 to finance the energy plant, the developer may offer to sell 1,000,000 future tokens for $0.25 each. Each future token entitles the purchasing owner to $1.00 from the revenue stream generated from the energy plant. A current owner of a future token may transfer ownership to a new owner who would be entitled to the remaining portion of the $1.00 that has not yet been paid. The aFTP system then publishes the terms of the project to elicit interests.

In some embodiments, the aFTP system receives, from prospective owners interested in financing the project, a commitment of funds to purchase future tokens. Continuing with the example, one hundred prospective owners may each commit $2,500 to each purchase 10,000 future tokens (e.g., each with a future value of $1.00). Each prospective owner may transfer to an escrow account the value of their commitment (e.g., $2,500). The commitment may be realized by transfer of the commitment amount in fiat currency to an escrow bank account owned by the aFTP system, in cryptocurrency to an escrow account of the aFTP system, or by purchase of exchange tokens (described below) represented by exchange token transactions recorded in the distributed ledger that are transferred to an escrow account of the aFTP system, and so on.

In some embodiments, when the commitments of the prospective owners are sufficient to cover the allocation number of future tokens, the aFTP system transfers ownership of the future tokens from the developer to the new owners based on the commitment amount of each owner. Continuing with the example, the aFTP system would transfer 10,000 future tokens to each prospective owner.

In some embodiments, the aFTP system maintains an accounting of revenue realized from the revenue stream that has been allocated to each future token. When a revenue amount of the revenue stream is realized (e.g., on a daily basis), the aFTP system adjusts the revenue account of each owner of a future token to reflect the portion of the revenue amount based on the number of future tokens owned by that owner. Continuing with the example, if the revenue amount is $10,000, then each future token would be allocated $0.01. Since each owner owns 10,000 future tokens, the aFTP system adds $100 ($0.01×10,000) to the revenue account of each owner. The aFTP system may maintain the accounting in the distributed ledger. The aFTP system may record a revenue index transaction with a smart contract for maintaining the accounting. Whenever a revenue amount is realized, the aFTP system may send a payment message to the revenue index transaction. Upon receiving the message, the smart contract accesses each future token to identify the current owner and updates the account of the current owner. The aFTP system may also record in the distributed ledger a total revenue realized transaction (or revenue transaction) and for each revenue amount that is realized, a revenue realized transaction (e.g., daily revenue transaction). The total revenue transaction includes a smart contract that maintains total revenue that has been realized (e.g., per future token). Each revenue realized transaction records the revenue amount realized (e.g., on a daily basis) to be allocated to the accounts of the owners of the future tokens. An owner can access the total revenue realized transaction (or the individual revenue realized transactions) to determine the amount that has been already realized. The owner of a future token can transfer the future token to a new owner. Prior to the transfer, the new owner can access total revenue realized transaction to determine the revenue amount that has not yet been realized.

In some embodiments, the aFTP system maintains the revenue that has been realized in a realized escrow account (e.g., bank account) pending redemption by an owner (or prior owner who owned a future token when the revenue was realized). An owner who want to have their revenue account settled (in whole or in part) requests the aFTP system to settle their revenue account. To settle a revenue account, the aFTP system sends a settle message to the revenue index transaction specifying the owner and the settlement amount. The smart contract of the revenue index transaction debits the revenue account of the owner and records in the distributed ledger one or more exchange token transactions owned by the owner with a total exchange value of the settlement amount. For example, if the revenue account had a balance of $1,000 and the settlement amount was $900, then the smart contract would adjust the balance to $100 and record in the distributed ledger exchange tokens with a value of $900 (e.g., record 900 exchange tokens with a value of $1.00 each). The aFTP system may provide an exchange platform through which an owner of an exchange token can redeem the exchange token for its value. When redeemed, the aFTP system pays the owner of the exchange token out of and adjusts the realized escrow account.

Although the future tokens and exchange tokens are described primarily each having a $1.00 value, an implementation of the aFTP system can employ a different value (e.g., $100) or even a variable value. A token with a variable amount can be split into multiple tokens, and multiple tokens can be combined into a single token. In addition, the distributed ledger may be a blockchain that is implemented, for example, with the Ethereum platform.

The following diagrams illustrate an example embodiment of the aFTP system. Different embodiments may, for example, not employ commit tokens, combine the functions of the daily revenue index, the revenue, and the daily revenue smart contracts into a single smart contract, and so on.

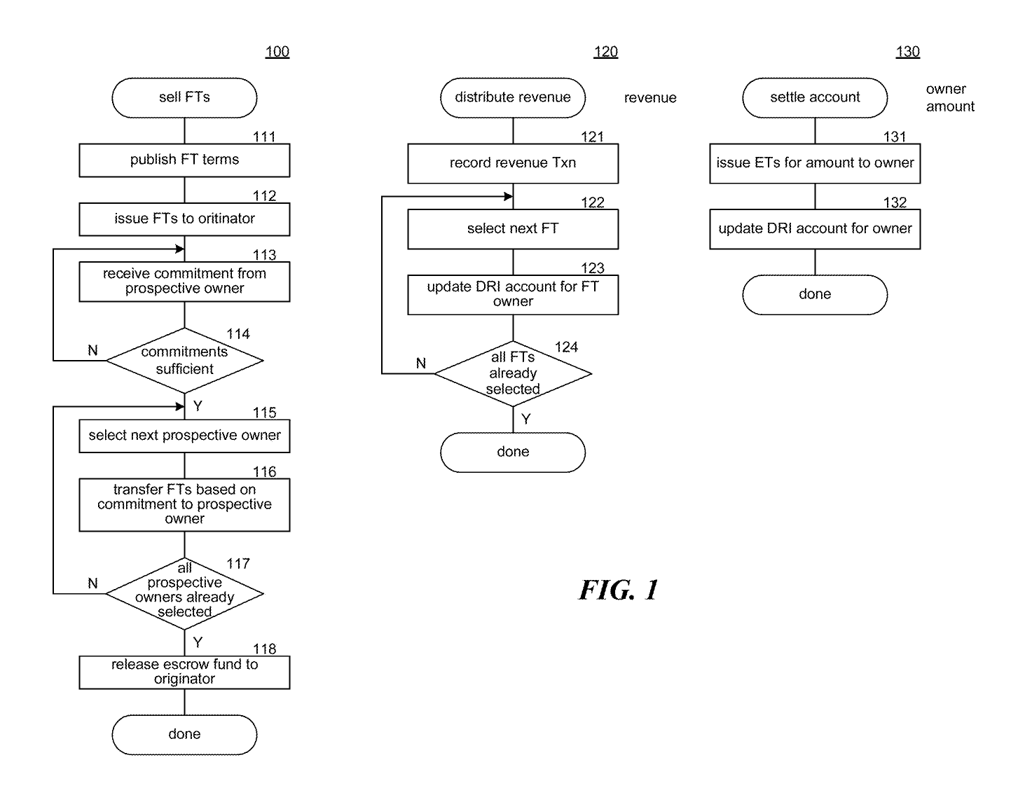

FIG. 1 flow diagrams that illustrate the processing of the aFTP system in some embodiments. The aFTP system 100 includes a sell future tokens component 110, a distribute revenue component 120, and a settle account component 130. The sell future tokens component is invoked when an originator seeks to sell future tokens. In block 111, the component publishes the terms of the future token as specified by the originator. In block 112, the component issues the future tokens to the originator. In block 113, the component receives a commitment from a prospective owner who has presumably reviewed the published terms, which may also be recorded in the distributed ledgers. In decision block 114, if the commitments are sufficient to satisfy the published terms, then the component continues at block 115, else the component loops to block 113 to wait for additional commitments. In block 115, the component selects the next prospective owner. In block 116, the component transfers future tokens for the originator to the perspective owner as a new owner. In decision block 117, if all prospective owners have already been selected, then the component continues at block 118, else the component loops to block 115. In block 118, the component directs the release of the funds in escrow to the originator and completes.

The distribute revenue component is invoked when revenue is realized. In block 121, the component records a revenue realized transaction in the distributed ledger to indicate the revenue realized. In blocks 122-124, the component loops distributing the revenue realized to the revenue accounts of the owners of the future tokens. In block 122, the component selects the next future token. In block 123, the component updates the revenue account of the owner in a daily revenue index (“DRI”) that may be maintained in the distributed ledger. In decision block 124, if all the future tokens have already been selected, then all realized revenue has been distributed and the component completes, else the component loops to block 122 to select the next future token.

The settle account component is invoked when a request to settle a revenue account track by the DRI. The component is passed an indication of the owner and settlement amount. In block 131, the component issues one or more exchange tokens for the amount to be settled. In block 132, the component updates the revenue account for the owner and completes.

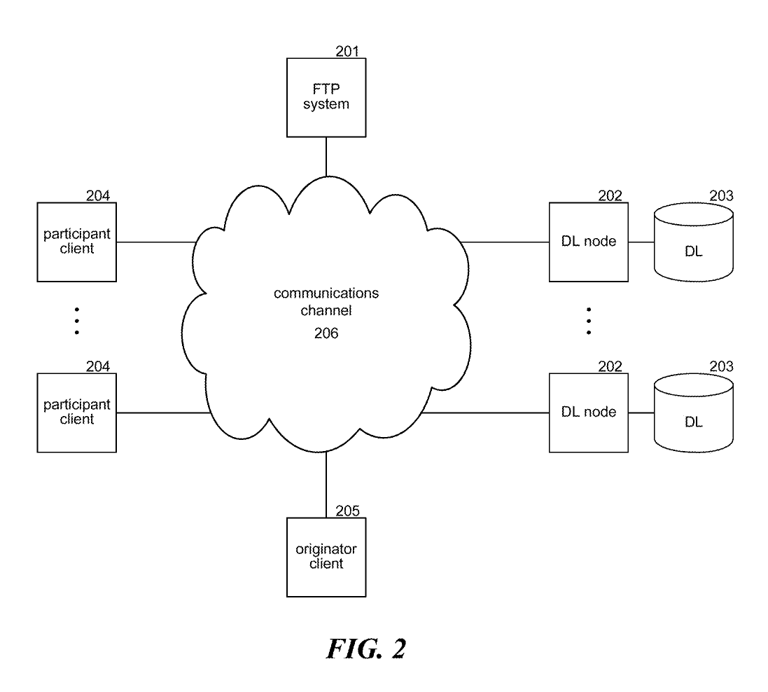

FIG. 2 is a block diagram that illustrates systems that interact with the aFTP system in some embodiments. The systems communicate via communications channel 206 such as the Internet. The aFTP system 201 interfaces with a distributed ledger implemented on distributed ledger nodes 202. Each node has access to a copy of the distributed ledger 203. To record a transaction, the transaction is distributed to each of the distributed ledger nodes. The aFTP system also interacts with one or more originator clients 205 that each originates one or more projects, whose terms may be recorded in the distributed ledger. The aFTP system interacts with participant clients 204 who commit to purchase future tokens, request to settle revenue accounts, request to exchange exchange tokens, and so on.

The computing systems (e.g., network nodes or collections of network nodes) on which the aFTP system an FTP system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the aFTP system and the FTP system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The aFTP system and the FTP system may be described in the general context of computer-executable instructions, such as program modules and components, executed by one or more computers, processors, or other devices. Generally, program modules or components include routines, programs, objects, data structures, and so on that perform tasks or implement data types of the aFTP system and the FTP system. Typically, the functionality of the program modules may be combined or distributed as desired in various examples. Aspects of the aFTP system and the FTP system may be implemented in hardware using, for example, an application-specific integrated circuit (“ASIC”) or field programmable gate array (“FPGA”).

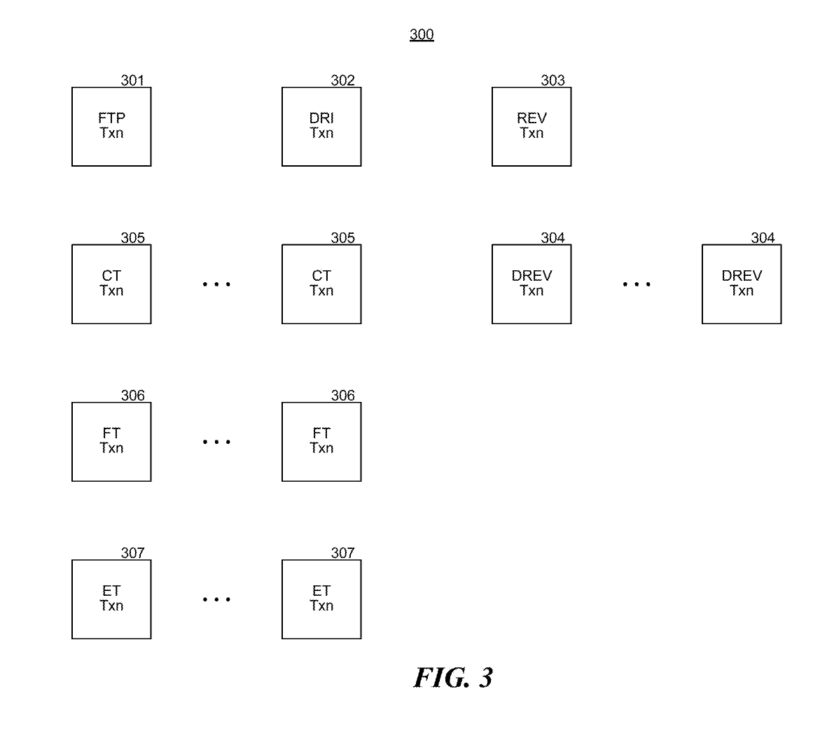

FIG. 3 is a diagram that illustrates various transactions that are recorded in the distributed ledger by the aFTP system in some embodiments. Each of the transactions may have an associated smart contract, which are components of the aFTP system. Each smart contract implements functions of the aFTP system. An aFTP transaction 301 is recorded for each project to manage the commitments and issuances of future tokens. A DRI transaction 301 maintains a daily revenue index (“DRI”) to update current accounts of future token owners based on realized revenue on a daily basis. A revenue transaction 303 tracks the total revenue that has been realized for a project. A daily revenue (“DREV”) transaction 304 is recorded each day to record the revenue realized for that day. Commit token (“CT”) transactions 305 may be issued to prospective owners who commit to purchase future tokens on a one-for-one basis. The owner of a commit token can transfer ownership. When the allocation for the project is fully committed, then a future token may be transferred to the current owner of each commit token. Future token (“FT”) transactions 306 are recorded to track ownership of future tokens. Exchange tokens (“ET”) 307 are recorded when the revenue account of an owner of future token is settled.

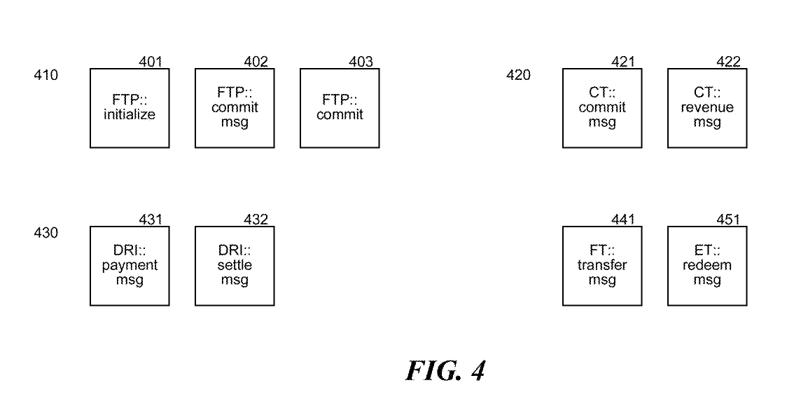

FIG. 4 illustrates components of various smart contracts in some embodiments. The aFTP smart contract 401 includes an initialize component 401, a commit message component 402, and a commit component 403. The commit token smart contract 420 includes a commit message component 421 and revenue message component 422. A DRI smart contract 430 includes a payment message component 431 and a settle message component 432. The future token smart contract includes a transfer message component 441, and the exchange token smart contract includes redeem message component 450.

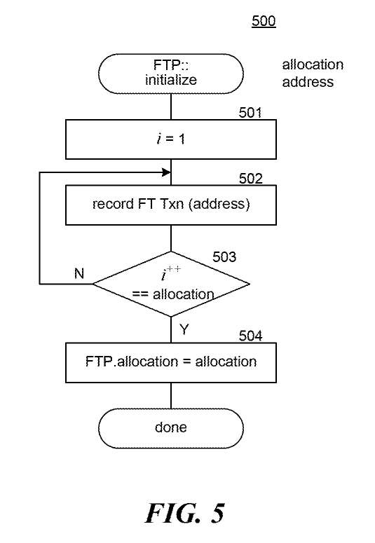

FIG. 5 is a flow diagram that illustrates the processing of an aFTP initialize component. The initialize component 500 may be invoked when the smart contract is constructed and is passed an indication of an allocation number of future tokens and the address of the originator. The address may be the hash of the public key of the originator. In block 501, the component sets an index i to 1 for indexing through the future tokens to be allocated. In block 502, the component records a future token transaction with the owner specified by the address. In block 503, if the index i equals to the number of future tokens to be allocated, then the component continues at block 504, else the component increments index i and loops to block 502 to record the next future token transaction. In block 504, the component sets an allocation field of the smart contract to record the number of future tokens that have been recorded and completes.

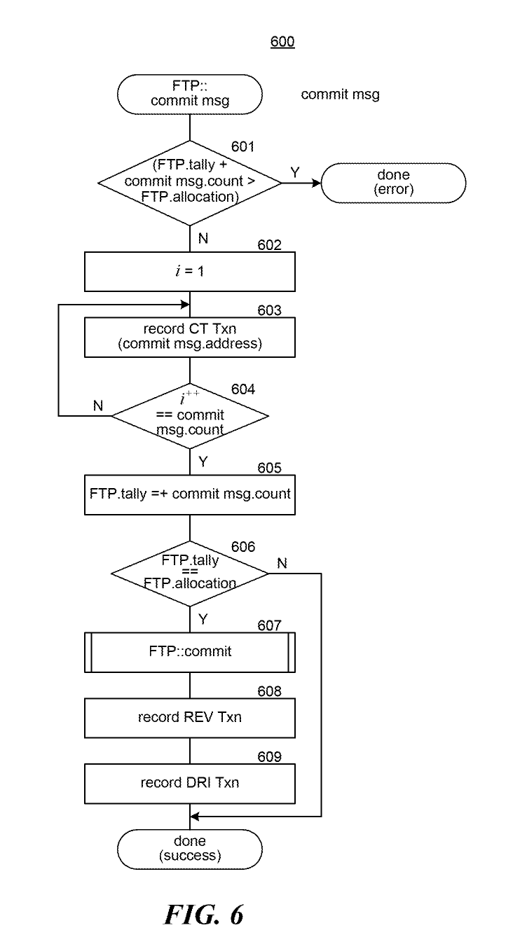

FIG. 6 is a flow diagram that illustrates the processing of a commit message component of the aFTP smart contract in some embodiments. The commit message component 600 is invoked when a commit message is received by the smart contract. The component records the commitment and, if fully committed, directs the transfer of ownership of the future tokens to the new owners. In decision block 601, if the current tally of commitments plus the number of tokens to be committed is greater than the allocation amount, then the component completes indicating an error, else the component continues at block 602. In block 602, the component increments an index i for indexing through the number of tokens to be committed. In block 603, the component records a commit transaction indicating the owner as specified by the address of the commit message. In decision block 604, if the index i is equal to the count of the commit message, then the component continues at block 605, else the component increments index i loops to block 603 to record another commit transaction. In block 605, the component increments a running tally of the count of commitments by the count of the commit message. In decision block 606, if the tally equals the allocation for the project, then component continues at block 607, else the component completes indicating success. In block 607, the component invokes a commit component to transfer ownership of the future tokens based on the ownership of the commit tokens. In block 608, the component records a total revenue transaction for tracking the total revenue. In block 609, the component records a DRI transaction to track the revenue accounts of the owners of the future tokens and completes indicating success.

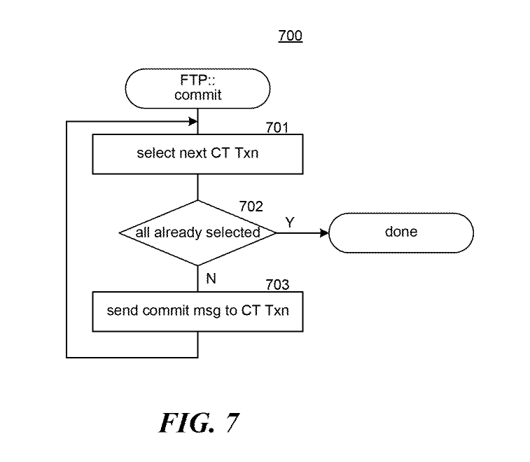

FIG. 7 is a flow diagram that illustrates the processing of a commit component of the aFTP smart contract in some embodiments. The commit component directs the commit token transactions to the transfer ownership of a future time. In block 701, the component selects the next commit token transaction. In decision block 702, if all the commit token transactions of the distributed ledger have already been selected, then the component completes, else the component continues at block 703. In block 703, the component sends a commit message to the selected commit token transaction and loops to block 701 to select the next commit token transaction.

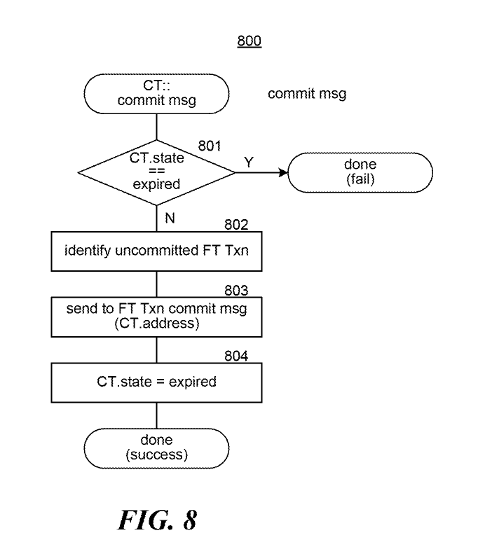

FIG. 8 is a flow diagram that illustrates the processing of a commit message component of a commit token smart contract in some embodiments. The commit message component is invoked when a commit message is received by the commit token transaction. In decision block 801, if the commit token transaction indicates that its state is expired, then the component completes indicating failure, else the component continues at block 802. In block 802, the component identifies an uncommitted future token transaction. In block 802, the component sends to the identified future token transaction a payment message indicating the address of the owner of the commit token transaction. In block 804, the component sets the state of the commit token transaction to expired and then completes indicating success.

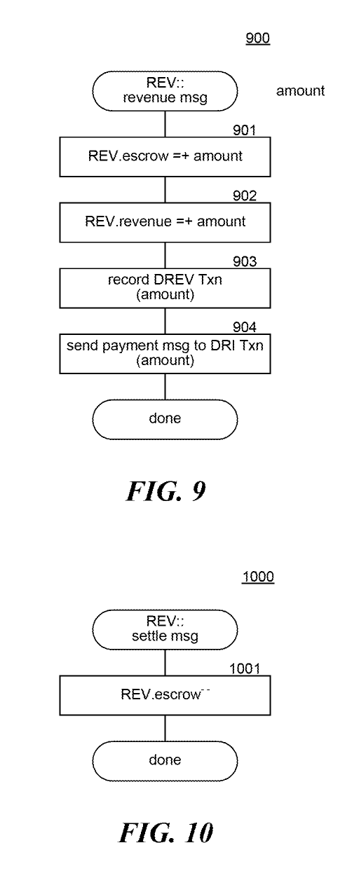

FIG. 9 is a flow diagram that illustrates the processing of a revenue message component of a total revenue transaction smart contract in some embodiments. The revenue message component is invoked when a revenue message is received by the total revenue transaction. A revenue message indicates the amount of the realized revenue. In block 901, the component increases the escrow balance by the amount of the revenue realized. The escrow balance reflects the amount of revenue realized that has not yet been settled. In block 902, the component increases the amount of the total revenue by the amount of the revenue realized. In block 903, the component records a daily revenue transaction that specifies the amount of the revenue realized. In block 904, the component sends a payment message to the daily revenue index transaction that specifies the revenue realized and then completes.

FIG. 10 is a flow diagram that illustrates the processing of a settlement message component of the total revenue smart contract in some embodiments. The settlement message component is invoked when a settlement message is received by the total revenue smart contract. In block 1001, the component decrements the amount of the escrow balance assuming that each exchange token is issued with a valuable one dollar. The component then completes.

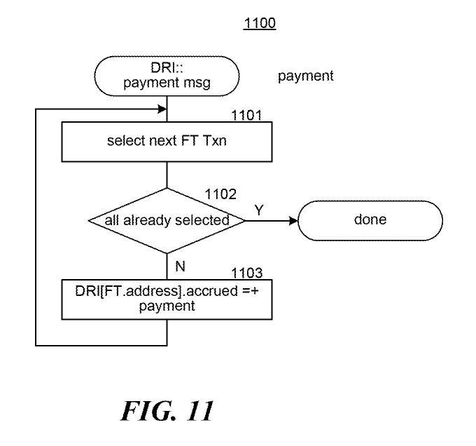

FIG. 11 is a flow diagram that illustrates the processing of a payment message component of a daily revenue index smart contract in some embodiments. The payment message component 1100 is invoked when a payment message is received by the daily revenue index transaction. The payment message indicates the payment amount that is realized by each future token. In block 1101, the component selects the next future token transaction. In decision block 1102, if all future contract transactions have already been selected, then the component completes, else the component continues at block 1103. In block 1103, the component increases the revenue account for the owner of the selected future token transaction by the payment amount and then loops to block 1101 to select the next future token transaction.

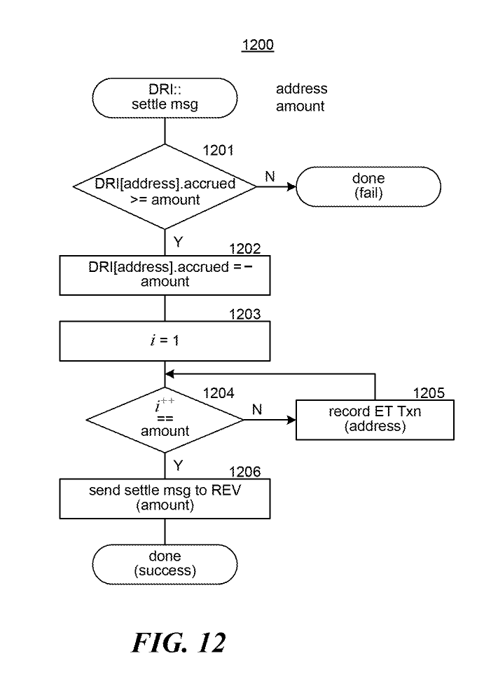

FIG. 12 is a flow diagram that illustrates the processing of a settlement message component of a daily revenue index smart contract in some embodiments. The settlement message component 1200 is invoked when a settlement message is received by the daily revenue index transaction. The settlement message indicates an address and an amount to be settled. In decision block 1201, if the accrued amount for the address is greater than or equal to the settlement amount, then the component continues at block 1202, else the component completes indicating failure. In block 1202, the component increases the revenue account balance by the amount. In block 1203, the component initializes an index i to 1 for indexing through exchange tokens to be issued. In decision block 1201, if the value of the index i is equal to the settlement amount, (and also increments the index), then the component continues at block 1206, else the component continues at block 1205. In block 1205, the component records and exchanges token transaction indicating the address specified in settlement message as the owner and loops to block 1204. In block 1206, the component sends a settlement message to the total revenue transaction indicating the settlement amount.

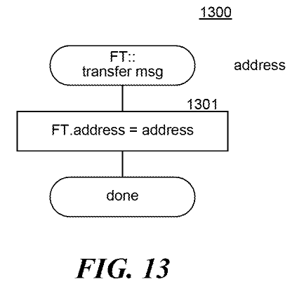

FIG. 13 is a flow diagram that illustrates the processing of a transfer message component of a future token smart contract in some embodiments. The transfer message component is invoked when a transfer message is received by the future token transaction and transfers the ownership of the future token to the address of the message. In block 1301, the component sets the address of the future token to the address of the transfer message and completes.

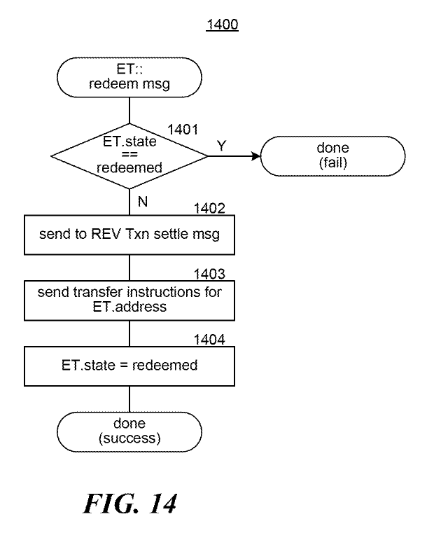

FIG. 14 is a flow diagram that illustrates the processing of redeem message component of exchange token smart contract in some embodiments. The redeem message component 1400 is invoked when the exchange token transaction receives the redeem message. In decision block 1401, if the current state of the exchange token indicates that it has already been redeemed, then the component completes indicating failure, else the component continues at block 1402. In block 1402, the component sends to the total revenue transaction a settlement message. In block 1403, the component sends a transfer instruction for the owner of the exchange token. The transfer instruction, for example, may be sent to a bank system for transferring funds from the bank account that holds the escrow account for the realized revenue to the bank account of the owner of the exchange token. In block 1406, the component records the state of the exchange tokens being redeemed and completes indicating success.

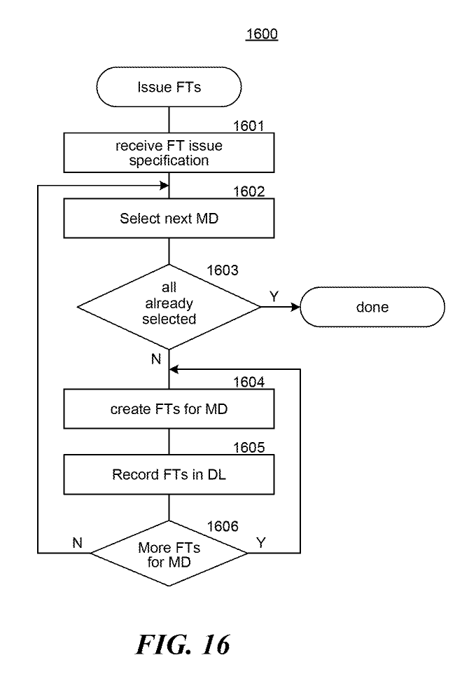

FIG. 16 is a flow diagram that illustrates a component for issuing FTs of the FTP system in some embodiments. An issue FTs component 1600 is invoked to issue FTs. In block 1601, the component receives an FT issue specification. The FT issue specification specifies for each maturity date the number of FTs to be issued with that maturity date. In block 1601, the component selects the next maturity date. In decision block 1603, if all the maturity dates have already been selected, then the component completes, else the component continues at block 1604. In block 1604, the component creates FT with the selected maturity date. In block 1605, the component records the FT in the distributed ledger. In decision block 1606, if more FTs are to be issued for the selected maturity date, then the component loops to block 1604 two continue creating FTs, else the component loops to block 1602 to select the next maturity date.

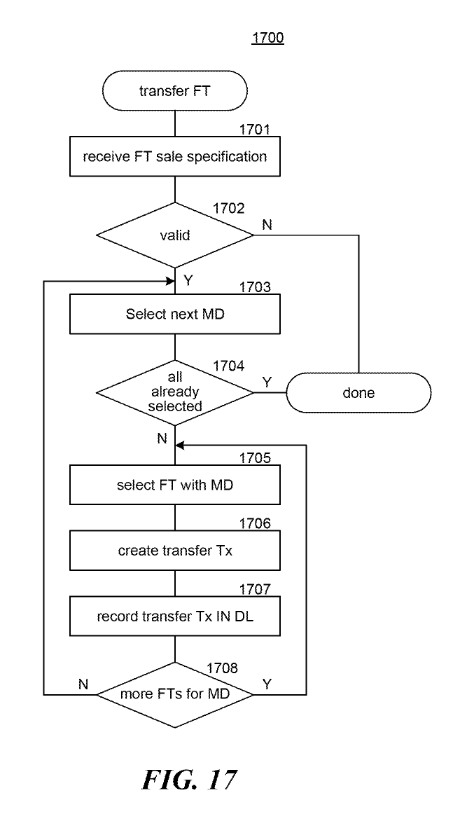

FIG. 17 is a flow diagram that illustrates a component for transferring FTs of the FTP system in some embodiments. A transfer FT component 1700 coordinates the transferring of FTs from one owner to another owner. In block 1701, the component receives an FT sale specification. An FT sale specification indicates the number of FTs with a specified maturity dates to be transferred to the new owner. Alternatively, the FT sale specification may identify the individual FTs to be transferred. In decision block 1702, if the sale specification is valid, then the component continues at block 1703, else the component completes. AN FT sale specification may be invalid, for example, if the owner does not own sufficient FTs to support the sale. In block 1703, the component selects the next maturity date of the sale specification. In decision block 1704, if all the maturity dates of already been selected, then the transfers complete and the component completes, else the component continues at block 1705. In block 1705, the component selects an FT with the selected maturity date. In block 1706, the component creates a transfer transaction for the selected FT. In block 1707, the component records the transferred transaction in the distributed ledger. In decision block 1708, if more FTs for the selected maturity date are to be transferred, the component loops to block 1705 two continue transferring, else the component continues at block 1703 to select the next maturity date.

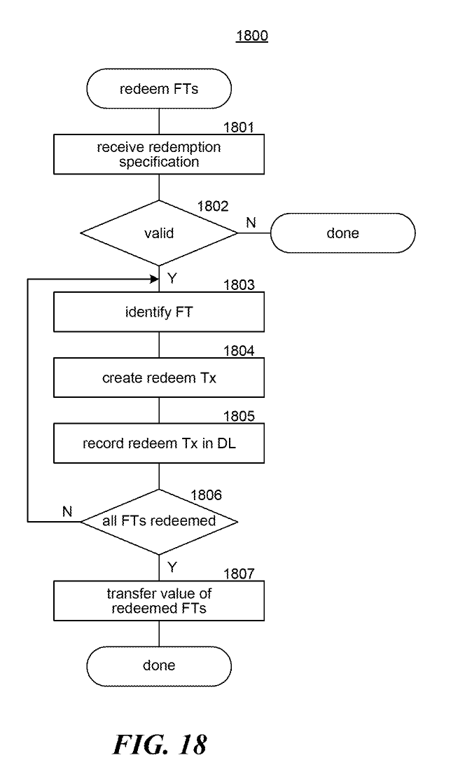

FIG. 18 is a flow diagram that illustrates processing of a redeem FTs component of the FTP system in some embodiments. A redeem FTs component 1800 is invoked to redeem FTs. In block 1801, the component receives a redemption specification. A redemption specification may be similar to a sale specification indicating a number of FTs with their specified maturity dates. In decision block 1801, if the redemption specification is valid, then the component continues at block 1802, else the component continues at block 1803. A redemption specification may be invalid if the party submitting the redemption specification does not own a sufficient number of FTs. In block 1803, the component identifies a future token to redeem based on the redemption specification. In block 1804, the component creates a redemption transaction for the identified FT. In block 1805, the component records a redemption transaction in the distributed ledger. In decision block 1806, if all the FTs have been redeemed, then the component continues at block 1807, else component loops to block 1803 to redeem the next identified FT.

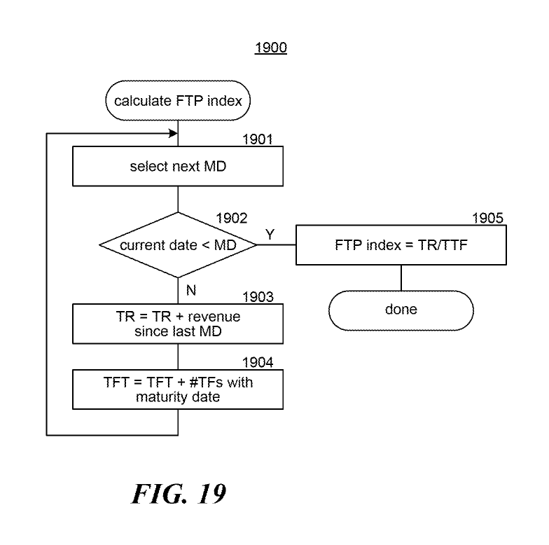

FIG. 19 is a flow diagram that illustrates processing of a calculate FTP index component of the FTP system in some embodiments. A calculate FTP index component 1900 is invoked to calculate and FTP index. In block 1901, the component selects the next maturity date. In decision block 1902, if the current date is less than the maturity date, then the component continues at block 1905, else the component continues at block 1903. In block 1903, the component adds the revenue since the last maturity date to a total revenue. In block 1904, the component adds the number of TF with the selected maturity date to a running total of the number of TF's. The component then loops to block 1901 to select the next maturity date. In block 1905, the component calculates the FTP index as the total revenue divided by the total number of TF's that have matured and then completes.

The following paragraphs describe various embodiments of aspects of the aFTP and FTP systems. An implementation of an aFTP system or FTP system may employ any combination of the embodiments. The processing described below may be performed by a computing device with a processor that executes computer-executable instructions stored on a computer-readable storage medium that implements aFTP system or FTP system.

A method performed by one or more computing systems for issuing FTs representing interest in future revenue is provided. The method receives an issue specification indicating number of FTs and their maturity dates that are to be issued and an owner of the FTs. For each maturity date of the issue specification and for each FT to be issued with that maturity date, the method creates an FT indicating that maturity date and the owner and records recording in a distributed ledger the FT. In some embodiments, the method further calculates an index representing the actual revenue per FT that has matured. In some embodiments, the method further records in the distributed ledger a maturity date transaction indicating that the maturity date of an FT has been changed. In some embodiments, the maturity date transaction is recorded when the actual revenue is less than the anticipated revenue at a maturity date. In some embodiments, the method further records in the distributed ledger a redeemed transaction for an FT when that FT is redeemed for payment. In some embodiments, the method further records in the disturbed ledger a transfer transaction for an FT when the FT is transferred to a new owner. In some embodiments, the method further records in the distributed ledger an issuance transaction with a smart contract for controlling the issuing of FTs. In some embodiments, the number of FTs issued is based on the value of the anticipated future revenue. In some embodiments, the number and maturity dates of the FT to be issued is based on desired total proceeds from sale of the issued FTs. In some embodiments, the future revenue is from a renewable energy plant that is to be constructed. In some embodiments, the number and maturity dates of the FT to be issued is based on desired total proceeds from sale of the issued FTs with be sufficient to pay for the construction.

In some embodiments, a method performed by one or more computing systems for issuing future tokens for a revenue stream is provided. The method receives from an originator of the revenue stream an allocation number of future tokens. The method records in a distributed ledger the allocation number of future token transactions with the originator as an original owner. Each future token entitling an owner to a fixed amount of the revenue stream. The method receives from a plurality of prospective owners a commitment of funds to purchase future tokens. When the commitments of the prospective owners are sufficient, the method transfers ownership of the future tokens to the prospective owners. The method then directs release of the funds to an originator. In some embodiments, the revenue stream is from a project to be developed by the originator. In some embodiments, the project is an energy plant. In some embodiments, the energy plant is a renewable energy plant. In some embodiments, the method records in the distributed ledger a revenue index transaction with a smart contract for maintaining a revenue index for receiving revenue messages indicating a revenue amount and updating the revenue index for each current owner of a future token to indicate a payment amount to be paid to each current owner based on the number of future tokens owned by each current owner. In some embodiments, the method when a revenue amount is to be paid to current owners of future tokens, records in the distribute ledger an individual revenue transaction indicating the revenue amount. In some embodiments, the method for each owner, maintains a balance indicating amount of the revenue stream to be paid to the owner and upon receiving a request to settle a settlement amount portion of the balance for an owner, records in the distributed ledger one or more exchange tokens that are exchangeable for the settlement amount of currency. In some embodiments, the method when a revenue amount of the revenue stream is to be allocated to the current owners of the future tokens, allocates a portion of the revenue amount to each owner of a future token. In some embodiments, when a future token is transferred to a new owner, the new owner is entitled the portion of the fix amount that has not already been allocated for that future token to a prior owner of the future token.

In some embodiments, one or more computing systems for issuing FT representing interest in future revenue of a renewable energy plant is provided. The one or more computing systems includes one or more computer-readable storage mediums for storing computer-executable instructions for controlling the one or more computing systems and one or more processors for executing the computer-executable instructions stored in the one or more computer-readable storage mediums. The instructions for receiving an issue specification indicating number of FTs and their maturity dates that are to be issued and an owner of the FTs. For each FT to be issued, the instructions for creating an FT indicating a maturity date and the owner as specified by the issue specification and recording the FT in a blockchain. In some embodiments, the instructions further for calculating an index representing actual revenue of the power plant per FT that has matured. In some embodiments, instructions further for recording record in the blockchain a maturity date transaction for an FT indicating that the maturity date of the FT has been changed. In some embodiments, the maturity date transaction is recorded when the actual revenue is less than the anticipated revenue at a maturity date. In some embodiments, the instructions further for recording in the blockchain a redeemed transaction for an FT when that FT is redeemed for payment. In some embodiments, the instructions further for recording in the blockchain a transfer transaction for an FT when the FT is transferred to a new owner. In some embodiments, the instructions further for recording in the distributed ledger an issuance transaction with a smart contract for controlling the issuing of FTs. In some embodiments, the number of FTs issued is based on the value of anticipated future revenue. In some embodiments, the number and maturity dates of FTs to be issued is based on desired total proceeds from sale of the issued FTs. In some embodiments, the number and maturity dates of FTs to be issued is based on desired total proceeds from sale of the issued FTs with be sufficient to pay for construction of the renewable energy plant.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

We claim:

1. A method performed by one or more computing systems for issuing future tokens (“FTs”) representing interest in future revenue, the method comprising:
receiving an issue specification indicating number of FTs and their maturity dates that are to be issued and an owner of the FTs; and
for each maturity date of the issue specification,
for each FT to be issued with that maturity date,
creating an FT indicating that maturity date and the owner; and
recording in a distributed ledger the FT.

2. The method of claim 1 further comprising calculating an index representing the actual revenue per FT that has matured.

3. The method of claim 1 further comprising recording in the distributed ledger a maturity date transaction indicating that the maturity date of an FT has been changed.

4. The method of claim 3 wherein the maturity date transaction is recorded when the actual revenue is less than the anticipated revenue at a maturity date.

5. The method of claim 1 further comprising recording in the distributed ledger a redeemed transaction for an FT when that FT is redeemed for payment.

6. The method of claim 1 further comprising recording in the disturbed ledger a transfer transaction for an FT when the FT is transferred to a new owner.

7. The method of claim 1 further comprising recording in the distributed ledger an issuance transaction with a smart contract for controlling the issuing of FTs.

8. The method of claim 1 wherein the number of FTs issued is based on the value of the anticipated future revenue.

9. The method of claim 1 wherein number and maturity dates of the FT to be issued is based on desired total proceeds from sale of the issued FTs.

10. The method of claim 1 wherein the future revenue is from a renewable energy plant that is to be constructed.

11. The method of claim 10 wherein number and maturity dates of the FT to be issued is based on desired total proceeds from sale of the issued FTs with be sufficient to pay for the construction.

12. A method performed by one or more computing systems for issuing future tokens for a revenue stream, the method comprising:
receiving from an originator of the revenue stream an allocation number of future tokens;
recording in a distributed ledger the allocation number of future token transactions with the originator as an original owner, each future token entitling an owner to a fixed amount of the revenue stream;
receiving from a plurality of prospective owners a commitment of funds to purchase future tokens;
when the commitments of the prospective owners are sufficient, transferring ownership of the future tokens to the prospective owners; and
directing release of the funds to an originator.

13. The method of claim 12 wherein the revenue stream is from a project to be developed by the originator.

14. The method of claim 13 wherein the project is an energy plant.

15. The method of claim 14 wherein the energy plant is a renewable energy plant.

16. The method of claim 12 further comprising recording in the distributed ledger a revenue index transaction with a smart contract for maintaining a revenue index for receiving revenue messages indicating a revenue amount and updating the revenue index for each current owner of a future token to indicate a payment amount to be paid to each current owner based on the number of future tokens owned by each current owner.

17. The method of claim 12 further comprising when a revenue amount is to be paid to current owners of future tokens, recording in the distribute ledger an individual revenue transaction indicating the revenue amount.

18. The method of claim 12 further comprising, for each owner, maintaining a balance indicating amount of the revenue stream to be paid to the owner and upon receiving a request to settle a settlement amount portion of the balance for an owner, recording in the distributed ledger one or more exchange tokens that are exchangeable for the settlement amount of currency.

19. The method of claim 12 wherein when a revenue amount of the revenue stream is to be allocated to the current owners of the future tokens, allocating a portion of the revenue amount to each owner of a future token.

20. The method of claim 19 wherein when a future token is transferred to a new owner, the new owner is entitled the portion of the fix amount that has not already been allocated for that future token to a prior owner of the future token.

21. One or more computing systems for issuing future tokens (“FTs”) representing interest in future revenue of a renewable energy plant, the one or more computing systems comprising:
one or more computer-readable storage mediums for storing computer-executable instructions for controlling the one or more computing systems to:
receive an issue specification indicating number of FTs and their maturity dates that are to be issued and an owner of the FTs; and
for each FT to be issued,
create an FT indicating a maturity date and the owner as specified by the issue specification; and
record in a blockchain the FT; and
one or more processors for executing the computer-executable instructions stored in the one or more computer-readable storage mediums.

22. The one or more computing systems of claim 21 wherein the instructions further control the one or more computing systems to calculating an index representing actual revenue of the power plant per FT that has matured.

23. The one or more computing systems of claim 21 wherein the instructions further control the one or more computing systems to record in the blockchain a maturity date transaction for an FT indicating that the maturity date of the FT has been changed.

24. The one or more computing systems of claim 23 wherein the maturity date transaction is recorded when the actual revenue is less than the anticipated revenue at a maturity date.

25. The one or more computing systems of claim 21 wherein the instructions further control the one or more computing systems to record in the blockchain a redeemed transaction for an FT when that FT is redeemed for payment.

26. The one or more computing systems of claim 21 wherein the instructions further control the one or more computing systems to record in the blockchain a transfer transaction for an FT when the FT is transferred to a new owner.

27. The one or more computing systems of claim 21 wherein the instructions further control the one or more computing systems to record in the distributed ledger an issuance transaction with a smart contract for controlling the issuing of FTs.

28. The one or more computing systems of claim 21 wherein the number of FTs issued is based on the value of anticipated future revenue.

29. The one or more computing systems of claim 21 wherein number and maturity dates of FTs to be issued is based on desired total proceeds from sale of the issued FTs.

30. The one or more computing systems of claim 30 wherein number and maturity dates of FTs to be issued is based on desired total proceeds from sale of the issued FTs with be sufficient to pay for construction of the renewable energy plant.
